(19) United States
(12) Patent Application Publication
(10) Pub. No.: US 2017/0351667 A1
(43) Pub. Date: Dec. 7, 2017

(54) TRANSACTION PROCESSING METHOD, PROCESSING NODE, CENTRAL NODE, AND CLUSTER

(71) Applicant: Huawei Technologies Co., Ltd., Shenzhen (CN)

(72) Inventors: Yuanyuan Nie, Beijing (CN); Jijun Wen, Shenzhen (CN); Jian Li, Beijing (CN)

(21) Appl. No.: 15/686,633

(22) Filed: Aug. 25, 2017

Related U.S. Application Data
(63) Continuation of application No. PCT/CN2015/088346, filed on Aug. 28, 2015.

(30) Foreign Application Priority Data
Feb. 28, 2015 (CN) 201510091291.4

(51) Int. Cl. G06F 17/30

(52) U.S. Cl. CPC G06F 17/30008; G06F 17/30088

(57) ABSTRACT

The disclosure discloses a transaction processing method, a processing node, and a central node. The method includes: receiving, by the processing node in the cluster, global snapshot information according to a preset time interval, where the global snapshot information includes a transaction identifier of a running transaction in a cluster; storing the received global snapshot information in a cache; and processing the transaction according to the global snapshot information stored in the cache. In the transaction processing method, a central node in a cluster sends latest global snapshot information to each processing node according to a preset time interval, so that the processing node can store the global snapshot information. When applying for global snapshot information during transaction processing, the processing node does not need to obtain latest snapshot information from the central node. Therefore, network overheads can be reduced, and transaction processing efficiency can be improved.

### CROSS-REFERENCE TO RELATED APPLICATIONS

This application is a continuation of International Application No. PCT/CN2015/088346, filed on Aug. 28, 2015, which claims priority to Chinese Patent Application No. 201510091291.4 filed on Feb. 28, 2015. The disclosures of the aforementioned applications are hereby incorporated by reference in their entireties.

### TECHNICAL FIELD

The present application relates to the computer field, and in particular, to a transaction processing method, a processing node, a central node, and a cluster in the computer field.

### BACKGROUND

Multi-Version Concurrency Control (MVCC) is a mainstream database design mechanism. This mechanism is used in an Oracle database management system, an Innode storage engine, an SQL Server database management system, a PostgreSQL database management system, and the like. In the MVCC mechanism, to improve concurrent execution efficiency of a database, a new version is generated when a record is updated. Therefore, a record in the database may have multiple versions, and different versions of the record are visible to different read-write transactions. There is no mutual conflict between the read-write transactions, and the concurrent execution efficiency is high.

In a database management system based on the MVCC mechanism, when visibility of a record to different read-write transactions is determined, a transaction snapshot needs to be obtained. The transaction snapshot is used to indicate all running transactions at a particular time point, and different versions of transaction snapshots indicate all running transactions at different time points. For example, the system obtains a transaction snapshot at the beginning of a query and in an execution process, and determines, by using the transaction snapshot, whether a record being read is visible. If a transaction for which a record is inserted exists in the transaction snapshot, it indicates that the transaction for which the record is inserted is running at the beginning of the query. According to a transaction visibility rule, the record is invisible to a query record.

In a specific example, a statement 1 starts before a statement 2, and the statement 1 is running when the statement 2 starts. A record that is inserted or modified in a running process of the statement 1 is invisible to the statement 2. Even if the statement 1 is committed, a modification by the statement 1 is still invisible to the statement 2 in a later time segment. The foregoing mechanism may be implemented by using a transaction snapshot. A transaction snapshot is obtained at the beginning of the statement 2. Because the statement 1 is running at this moment, the transaction snapshot records a transaction of the statement 1. Whether a transaction corresponding to a record exists in the transaction snapshot is determined in an execution process of the statement 2, and if the transaction exists, the record is invisible.

Similarly, in a cluster environment, a node in a cluster also needs to obtain a transaction snapshot when executing a transaction, to ensure transaction visibility in the cluster environment. Generally, all transaction snapshots are managed and maintained by a central node or a central component. For example, in a Greenplum cluster, all transaction snapshots are managed by a coordinator node; in a PG-XC cluster, all transaction snapshots are managed by a dedicated component referred to as a global transaction manager (GTM).

In a cluster environment, a centralized allocation and obtaining manner is limited to a processing capability of a central node, which includes a network bandwidth limitation, a central processing unit (CPU) resource limitation, and the like of the central node. Each time a processing node obtains a transaction snapshot, the processing node needs to send a related message of the transaction snapshot to the central node, and then receive a result returned from the central node. Message sending and receiving speeds and a processing speed of the processing node have great impact on an obtaining speed. In a heavy load case, massive related messages of transaction snapshots are sent to the central node, and a network is filled with messages, resulting in a slow message processing speed. In addition, the central node needs to process massive requests, resulting in a slow processing speed, and greatly affecting concurrent processing performance of a cluster.

### SUMMARY

Embodiments of the present disclosure provide a transaction processing method, a processing node, a central node, and a cluster, to improve transaction processing efficiency of the cluster.

According to a first aspect, a transaction processing method is provided, including:
receiving, by a processing node in a cluster, global snapshot information sent by a central node in the cluster according to a preset time interval, where the global snapshot information includes a transaction identifier of a running transaction in the cluster;
storing, by the processing node, the received global snapshot information in a cache; and
processing, by the processing node, the transaction according to the global snapshot information stored in the cache.

With reference to the first aspect, in a first possible implementation manner of the first aspect, the global snapshot information further includes a snapshot version number, where the snapshot version number is used to identify a version of the global snapshot information, and the method further includes:
sending, to the central node when the processing node finishes processing the transaction, an update message that indicates an end of transaction processing of the processing node, so that the central node updates the global snapshot information according to the update message;
receiving, by the processing node, an acknowledgement message that is sent by the central node and that is used to indicate that the central node completes an update of the global snapshot information, where the acknowledgement message includes updated global snapshot information; and
comparing, by the processing node, a snapshot version number included in the global snapshot information in the acknowledgement message with the snapshot version number included in the global snapshot information stored in the cache, and updating, by the processing node, the global snapshot information stored in the cache to the global snapshot information in the acknowledgement message when the snapshot version number included in the global snapshot information in the acknowledgement message is higher than the snapshot version number included in the global snapshot information stored in the cache.

With reference to the first aspect or the first possible implementation manner of the first aspect, in a second possible implementation manner of the first aspect, the processing, by the processing node, the transaction according to the global snapshot information stored in the cache includes:
processing, by the processing node, the transaction according to the global snapshot information sent by the central node according to the preset time interval; or
processing, by the processing node, the transaction according to the global snapshot information included in the acknowledgement message sent by the central node, where the acknowledgement message is used to indicate that the central node completes the update of the global snapshot information according to the update message sent by the processing node, and the update message is used to indicate the end of the transaction processing of the processing node.

According to a second aspect, a transaction processing method is provided, including:
generating, by a central node in a cluster, global snapshot information, where the global snapshot information includes a transaction identifier of a running transaction in the cluster; and
sending, by the central node, the global snapshot information to a processing node in the cluster according to a preset time interval, so that the processing node processes the transaction according to the global snapshot information.

With reference to the second aspect, in a first possible implementation manner of the second aspect, the global snapshot information further includes a snapshot version number, and the snapshot version number is used to identify a version of the global snapshot information, so that the processing node updates global snapshot information in a cache according to a number of the version.

With reference to the second aspect or the first possible implementation manner of the second aspect, in a second possible implementation manner of the second aspect, the method further includes:
receiving, by the central node, an update message sent by the processing node, where the update message is used to indicate an end of transaction processing of the processing node;
updating, by the central node, the global snapshot information according to the update message; and
sending, by the central node, an acknowledgement message to the processing node, where the acknowledgement message includes updated global snapshot information.

According to a third aspect, a processing node is provided, where the processing node belongs to a cluster, and the processing node includes:
a receiving module, configured to receive global snapshot information sent by a central node in the cluster according to a preset time interval, where the global snapshot information includes a transaction identifier of a running transaction in the cluster;
a storage module, configured to store, in a cache, the global snapshot information received by the receiving module; and
a processing module, configured to process the transaction according to the global snapshot information stored in the cache.

With reference to the third aspect, in a first possible implementation manner of the third aspect, the global snapshot information further includes a snapshot version number, where the snapshot version number is used to identify a version of the global snapshot information, the processing node further includes:
a sending module, configured to send, to the central node when the processing node finishes processing the transaction, an update message that indicates an end of transaction processing of the processing node, so that the central node updates the global snapshot information according to the update message;
the receiving module is further configured to receive an acknowledgement message that is sent by the central node and that is used to indicate that the central node completes an update of the global snapshot information, where the acknowledgement message includes updated global snapshot information; and
the storage module is further configured to compare a snapshot version number included in the global snapshot information in the acknowledgement message received by the receiving module with the snapshot version number included in the global snapshot information stored in the cache, and the processing node updates the global snapshot information stored in the cache to the global snapshot information in the acknowledgement message when the snapshot version number included in the global snapshot information in the acknowledgement message is higher than the snapshot version number included in the global snapshot information stored in the cache.

With reference to the third aspect or the first possible implementation manner of the third aspect, in a second possible implementation manner of the third aspect, the processing module is specifically configured to:
process the transaction according to the global snapshot information sent by the central node according to the preset time interval; or
process the transaction according to the global snapshot information included in the acknowledgement message sent by the central node, where the acknowledgement message is used to indicate that the central node completes the update of the global snapshot information according to the update message sent by the processing node, and the update message is used to indicate the end of the transaction processing of the processing node.

According to a fourth aspect, a central node is provided, where the central node belongs to a cluster, and the central node includes:
a generation module, configured to generate global snapshot information, where the global snapshot information includes a transaction identifier of a running transaction in the cluster; and
a sending module, configured to send the global snapshot information generated by the generation module to a processing node in the cluster according to a preset time interval, so that the processing node processes the transaction according to the global snapshot information.

With reference to the fourth aspect, in a first possible implementation manner of the fourth aspect, the global snapshot information further includes a snapshot version number, and the snapshot version number is used to identify a version of the global snapshot information, so that the processing node updates global snapshot information in a cache according to a number of the version.

With reference to the fourth aspect or the first possible implementation manner of the fourth aspect, in a second possible implementation manner of the fourth aspect, the central node further includes:
a receiving module, configured to receive an update message sent by the processing node, where the update message is used to indicate an end of transaction processing of the processing node; and
an update module, configured to update the global snapshot information according to the update message received by the receiving module; and
the sending module is further configured to:
send an acknowledgement message to the processing node, where the acknowledgement message includes updated global snapshot information.

According to a fifth aspect, a cluster is provided, including multiple processing nodes according to the third aspect and the central node according to the fourth aspect.

Based on the foregoing technical solutions, in the transaction processing method, the processing node, the central node, and the cluster provided in the embodiments of the present disclosure, the central node in the cluster sends latest global snapshot information to each processing node according to a preset time interval, and the processing node stores the global snapshot information. When applying for global snapshot information during transaction processing, the processing node does not need to obtain latest snapshot information from the central node in a complex message receiving and transmitting manner, but obtains locally cached global snapshot information. Therefore, network overheads can be reduced, and transaction processing efficiency can be improved.

### BRIEF DESCRIPTION OF THE DRAWINGS

To describe the technical solutions in the embodiments of the present disclosure more clearly, the following briefly describes the accompanying drawings required for describing the embodiments of the present disclosure. Apparently, the accompanying drawings in the following description show merely some embodiments of the present disclosure, and a person of ordinary skill in the art may still derive other drawings from these accompanying drawings without creative efforts.

FIG. 1 is a schematic flowchart of a transaction processing method according to an embodiment in the present disclosure;

FIG. 2 is a schematic flowchart of a transaction processing method according to an embodiment in the present disclosure;

FIG. 3 is a schematic flowchart of a transaction processing method according to an embodiment in the present disclosure;

FIG. 4 is a schematic block diagram of a processing node according to an embodiment in the present disclosure;

FIG. 5 is a schematic block diagram of a processing node according to another embodiment in the present disclosure;

FIG. 6 is a schematic block diagram of a central node according to an embodiment in the present disclosure; and

FIG. 7 is a schematic block diagram of a central node according to another embodiment in the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are a part rather than all of the embodiments of the present disclosure. All other embodiments obtained by a person of ordinary skill in the art based on the embodiments of the present disclosure without creative efforts shall fall within the protection scope of the present disclosure.

The embodiments of the present disclosure are applicable to a distributed data processing system or a cluster environment. In a cluster, multiple servers are centralized to provide services of a same type. The cluster may be considered as one server from a perspective of a client. In the cluster, multiple computers are used to perform concurrent computing to obtain a high computing speed. The cluster includes a central node (CN) used for centralized scheduling and management, and multiple processing nodes (PN) used to execute a transaction. A central node in the embodiments of the present disclosure may be a coordinator node in a Greenplum cluster, a GTM component in a PG-XC cluster, or the like. The embodiments of the present disclosure may be further applicable to a distributed KEY/VALUE database, a distributed columnar database, a distributed graph database, or the like, which is not limited in the embodiments of the present disclosure.

It should be understood that global snapshot information in the embodiments of the present disclosure is used to indicate a global transaction snapshot, and the global transaction snapshot includes a transaction identifier of a running transaction in a cluster, so as to notify a processing node in the cluster of the current running transaction.

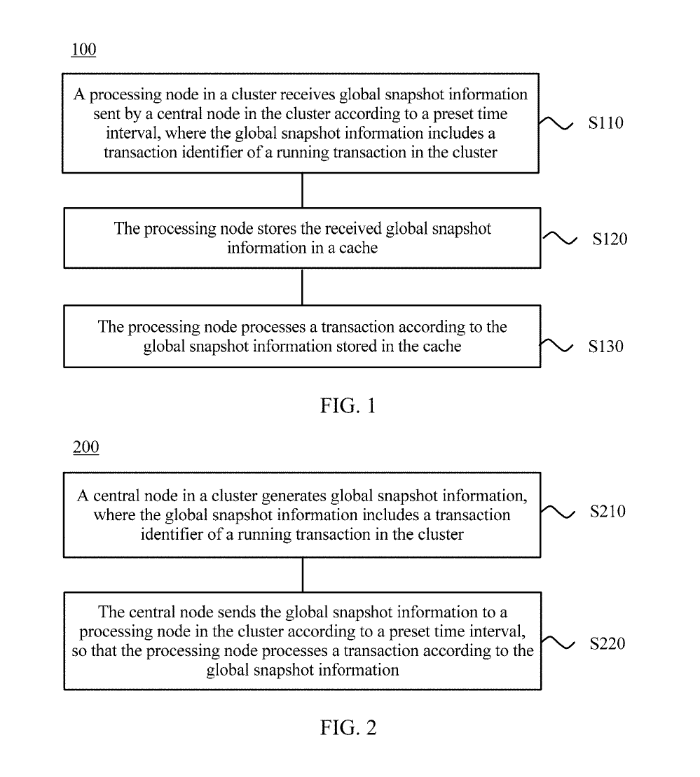

FIG. 1 shows a schematic flowchart of a transaction processing method 100 according to another embodiment in the present disclosure. The method 100 is executed by a processing node in a cluster, and the method 100 includes the following steps:

S110. The processing node in the cluster receives global snapshot information sent by a central node in the cluster according to a preset time interval, where the global snapshot information includes a transaction identifier of a running transaction in the cluster.

S120. The processing node stores the received global snapshot information in a cache.

S130. The processing node processes the transaction according to the global snapshot information stored in the cache.

Therefore, in the transaction processing method provided in this embodiment of the present disclosure, a processing node receives global snapshot information periodically sent by a central node, and locally caches the global snapshot information. When applying for global snapshot information during transaction processing, the processing node does not need to obtain latest snapshot information from the central node in a complex message receiving and transmitting manner, but obtains locally cached global snapshot information. Therefore, network overheads can be reduced, and transaction snapshot processing efficiency can be improved.

It should be understood that the foregoing transaction identifier may also be referred to as a transaction number.

Specifically, the processing node receives the global snapshot information that is periodically sent by the central node to the processing node, and stores the global snapshot information in the cache. The global snapshot information includes the transaction identifier of the running transaction in the cluster. The time interval for sending the global snapshot information by the central node to the processing node may be preset to 50 us, that is, the central node pushes latest global snapshot information every 50 us to all processing nodes. When the processing node needs to use global snapshot information, the processing node obtains the global snapshot information stored in the local cache to process the transaction.

When the processing node needs to use global snapshot information during transaction processing, the processing node no longer frequently interacts with the central node to obtain the global snapshot information, but obtains locally cached global snapshot information. Therefore, in a heavy load case, a quantity of message receiving and transmitting times on the central node is reduced, a processing speed of the central node can be ensured, and concurrent performance of the cluster can be improved. The global snapshot information locally cached by the processing node may be periodically sent by the central node to the processing node, or may be a periodically sent by the central node, which is not limited in this embodiment of the present disclosure.

Accordingly, that the processing node processes the transaction according to the global snapshot information stored in the cache includes:
processing, by the processing node, the transaction according to the global snapshot information sent by the central node according to the preset time interval; or
processing, by the processing node, the transaction according to global snapshot information included in an acknowledgement message sent by the central node, where the acknowledgement message is used to indicate that the central node completes an update of the global snapshot information according to an update message sent by the processing node, and the update message is used to indicate an end of transaction processing of the processing node.

Optionally, in an embodiment, the global snapshot information further includes a snapshot version number, where the snapshot version number is used to identify a version of the global snapshot information. The method 100 further includes:
sending, to the central node when the processing node finishes processing the transaction, the update message that indicates the end of the transaction processing of the processing node, so that the central node updates the global snapshot information according to the update message;
receiving, by the processing node, the acknowledgement message that is sent by the central node and that is used to indicate that the central node completes the update of the global snapshot information, where the acknowledgement message includes updated global snapshot information; and
comparing, by the processing node, a snapshot version number included in the global snapshot information in the acknowledgement message with the snapshot version number included in the global snapshot information stored in the cache, and updating, by the processing node, the global snapshot information stored in the cache to the global snapshot information in the acknowledgement message when the snapshot version number included in the global snapshot information in the acknowledgement message is higher than the snapshot version number included in the global snapshot information stored in the cache.

Specifically, when starting to process a non-read-only transaction, the processing node sends a first update message to the central node. The first update message is used to instruct the central node to update, according to a fact that the processing node starts to process the non-read-only transaction, global snapshot information stored by the central node. The updating includes updating the snapshot version number and recording the non-read-only transaction in the global snapshot information. For example, according to the first update message, the central node adds 1 to the snapshot version number in the global snapshot information relative to a previous version, and records a transaction identifier of the non-read-only transaction in the global snapshot information.

When finishing processing the read-only transaction, the processing node sends a second update message to the central node. The second update message is used to instruct the central node to update, according to a fact that the processing nodes finishes processing the non-read-only transaction, the global snapshot information stored by the central node. The updating includes updating the snapshot version number and deleting the non-read-only transaction from the global snapshot information. For example, according to the second update message, the central node adds 1 to the snapshot version number in the global snapshot information relative to a previous version, and deletes the transaction identifier of the non-read-only transaction from the global snapshot information.

After updating the stored global snapshot information according to the second update message, the central node sends the updated global snapshot information to the processing node by using the acknowledgement message. After receiving the updated global snapshot information, the processing node compares a snapshot version number in the updated global snapshot information with the snapshot version number in the global snapshot information stored in the cache. When the snapshot version number in the updated global snapshot information is higher than the snapshot version number included in the global snapshot information stored in the cache, the processing node updates the global snapshot information stored in the cache to the updated global snapshot information in the acknowledgement message. When the snapshot version number in the updated global snapshot information is equal to or less than the snapshot version number in the global snapshot information stored in the cache, the processing node may receive, during a period from sending the second update message to receiving the acknowledgement message, new global snapshot information pushed by the central node. In this case, the processing node does not update the global snapshot information stored in the cache. The acknowledgement message may be an ACK (Acknowledgement) message, or may be another control message, which is not limited in this embodiment of the present disclosure. In this embodiment of the present disclosure, relative accuracy and validity of the global snapshot information stored in the cache of the processing node can be ensured.

Therefore, in the transaction processing method provided in this embodiment of the present disclosure, a processing node receives global snapshot information periodically sent by a central node, and locally caches the global snapshot information. When applying for global snapshot information during transaction processing, the processing node does not need to obtain latest snapshot information from the central node in a complex message receiving and transmitting manner, but obtains locally cached global snapshot information. Therefore, network overheads can be reduced, and transaction snapshot processing efficiency can be improved.

The transaction processing method according to this embodiment of the present disclosure is described above in detail from a perspective of the processing node with reference to FIG. 1. A transaction processing method according to an embodiment of the present disclosure is described in the following in detail from a perspective of a central node with reference to FIG. 2.

FIG. 2 shows a schematic flowchart of a transaction processing method 200 according to an embodiment in the present disclosure. The method 200 is executed by a central node in a cluster, and the method 200 includes the following steps:

S210. The central node in the cluster generates global snapshot information, where the global snapshot information includes a transaction identifier of a running transaction in the cluster.

S220. The central node sends the global snapshot information to a processing node in the cluster according to a preset time interval, so that the processing node processes the transaction according to the global snapshot information.

Therefore, in the transaction processing method provided in this embodiment of the present disclosure, a central node in a cluster sends latest global snapshot information to each processing node according to a preset time interval, so that the processing node can store the global snapshot information. When applying for global snapshot information during transaction processing, the processing node does not need to obtain latest snapshot information from the central node in a complex message receiving and transmitting manner, but obtains locally cached global snapshot information. Therefore, network overheads can be reduced, and transaction processing efficiency can be improved.

Specifically, in an existing transaction snapshot processing method, during transaction processing, a processing node sends a message to a central node to request global snapshot information. After receiving the message requesting the global snapshot information, the central node returns an acknowledgement message and sends latest global snapshot information to the processing node. Massive messages need to be sent between the central node and the processing node in this process.

In the transaction snapshot processing method in this embodiment of the present disclosure, according to a related message that is sent by each processing node and that is about a start or an end of transaction processing of each processing node, the central node generates the global snapshot information in real-time and periodically sends the global snapshot information to the processing node. The global snapshot information includes the transaction identifier of the running transaction in the cluster, so that when the processing node needs to use global snapshot information, the processing node obtains locally cached global snapshot information to process the transaction. The time interval for sending the global snapshot information by the central node to the processing node may be preset to 50 us, that is, the central node pushes latest global snapshot information every 50 us to all processing nodes.

Optionally, in an embodiment, the global snapshot information further includes a snapshot version number, where the snapshot version number is used to identify a version of the global snapshot information, so that the processing node updates global snapshot information in a cache according to a number of the version.

Specifically, the central node may store multiple versions of global snapshot information at different time points, and store latest global snapshot information at a current time point. The global snapshot information not only includes the transaction identifier of the running transaction, but also includes the snapshot version number used to identify the version of the global snapshot information. Snapshot version numbers of different versions of global snapshot information may be set to monotonically increasing, for example, the setting may be that 1 is added to the snapshot version number each time the version is updated, which is not limited in this embodiment of the present disclosure. The snapshot version number is set in the global snapshot information, making it convenient for the processing node to update the global snapshot information in the cache according to a number of the version.

Optionally, in an embodiment, the method 200 further includes:
receiving, by the central node, an update message sent by the processing node, where the update message is used to indicate an end of transaction processing of the processing node;
updating, by the central node, the global snapshot information according to the update message; and
sending, by the central node, an acknowledgement message to the processing node, where the acknowledgement message includes updated global snapshot information.

Specifically, the central node is responsible for maintaining and updating the global snapshot information. When starting and finishing processing a non-read-only transaction, the processing node sends, to the central node, a message used to instruct the central node to perform updating, so that the central node updates the global snapshot information according to the message. For example, the central node updates the snapshot version number, the transaction identifier of the running transaction in the global snapshot information, and the like.

For example, when starting to process a non-read-only transaction, the processing node sends a first update message to the central node. The first update message is used to instruct the central node to update, according to a fact that the processing node starts to process the non-read-only transaction, global snapshot information stored by the central node. The updating includes updating the snapshot version number and recording the non-read-only transaction in the global snapshot information. For example, according to the first update message, the central node adds 1 to the snapshot version number in the global snapshot information relative to a previous version, and records a transaction identifier of the non-read-only transaction in the global snapshot information.

For another example, when finishing processing the non-read-only transaction, the processing node sends a second update message to the central node. The second update message is used to instruct the central node to update, according to a fact that the processing node finishes processing the non-read-only transaction according to the processing node, the global snapshot information stored by the central node. The updating includes updating the snapshot version number and deleting the non-read-only transaction from the global snapshot information. For example, according to the second update message, the central node adds 1 to the snapshot version number in the global snapshot information relative to a previous version, and deletes the transaction identifier of the non-read-only transaction from the global snapshot information.

After updating the stored global snapshot information according to the update message that is sent by the processing node and that is used to indicate that the processing node finishes processing the transaction, the central node sends the updated global snapshot information to the processing node by using the acknowledgement message. Therefore, global snapshot information that is stored in the cache of the processing node and that is used to perform the non-read-only transaction may be the global snapshot information periodically sent by the central node to the processing node; or the local transaction snapshot is the global snapshot information obtained after the central node updates, according to the update message, the global snapshot information stored by the central node.

After updating the stored global snapshot information, the central node sends the updated global snapshot information to the processing node by using the acknowledgement message, so that relative accuracy and validity of the global snapshot information stored in the cache of the processing node can be ensured. The acknowledgement message may be an ACK (Acknowledgement) message, or may be another control message, which is not limited in this embodiment of the present disclosure.

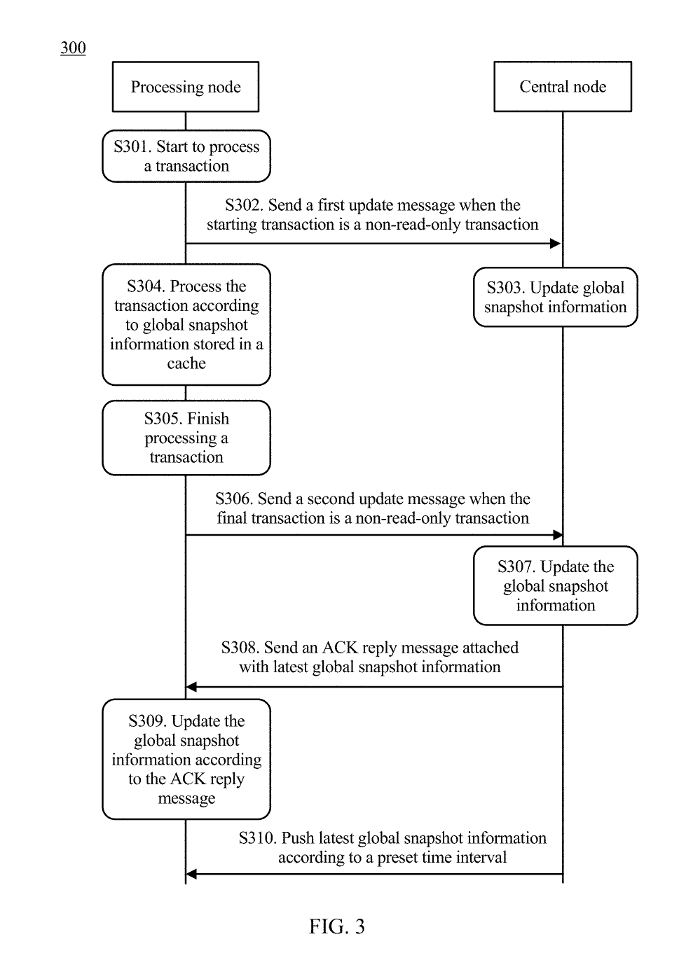

The transaction processing method in the embodiments of the present disclosure is described in the following in detail with reference to a specific example. FIG. 3 shows a schematic flowchart of a transaction processing method 300 according to an embodiment in the present disclosure. As shown in FIG. 3, the method 300 includes the following steps:

S301. A processing node starts to process the transaction.

S302. The processing node sends a first update message to a central node when the starting transaction is a non-read-only transaction, where the first update message instructs the central node to update, according to a fact that the processing node starts to process the non-read-only transaction, global snapshot information stored by the central node.

S303. The central node updates the stored global snapshot information, which includes: adding 1 to a snapshot version number in the global snapshot information relative to a previous version, and recording a transaction number of the non-read-only transaction in the global snapshot information.

S304. The processing node processes the transaction according to global snapshot information stored in a cache, and does not need to send a message to the central node.

S305. The processing node finishes processing a transaction.

S306. The processing node sends a second update message to the central node when the final transaction is a non-read-only transaction, where the second update message instructs the central node to update, according to a fact that the processing node starts to process the non-read-only transaction, the global snapshot information stored by the central node.

S307. The central node updates the stored global snapshot information, which includes: adding 1 to the snapshot version number in the global snapshot information relative to a previous version, and deleting a transaction number of the non-read-only transaction from the global snapshot information.

S308. The central node sends an ACK reply message to the processing node, where latest global snapshot information is attached in the ACK reply message.

S309. After receiving the ACK reply message, the processing node obtains the attached global snapshot information from the ACK reply message, compares a snapshot version number in locally cached global snapshot information with a snapshot version number in the global snapshot information attached in the ACK reply message, and updates the locally cached global snapshot information to the attached global snapshot information if the snapshot version number in the attached global snapshot information is higher than the snapshot version number in the locally cached global snapshot information.

S310. The central node pushes the global snapshot information to all processing nodes by using a message according to a preset time interval. The preset time interval may be configured as 50 us.

Therefore, in the transaction snapshot processing method, the processing node, the central node, and a cluster provided in this embodiment of the present disclosure, the central node in the cluster sends latest global snapshot information to each processing node according to a preset time interval, and the processing node stores the global snapshot information. When applying for global snapshot information during transaction processing, the processing node does not need to obtain latest snapshot information from the central node in a complex message receiving and transmitting manner, but obtains locally cached global snapshot information. Therefore, network overheads can be reduced, and transaction processing efficiency can be improved.

It should be understood that sequence numbers of the foregoing processes do not mean execution sequences in the embodiments of the present disclosure. The execution sequences of the processes should be determined according to functions and internal logic of the processes, and should not be construed as any limitation on the implementation processes of the embodiments of the present disclosure.

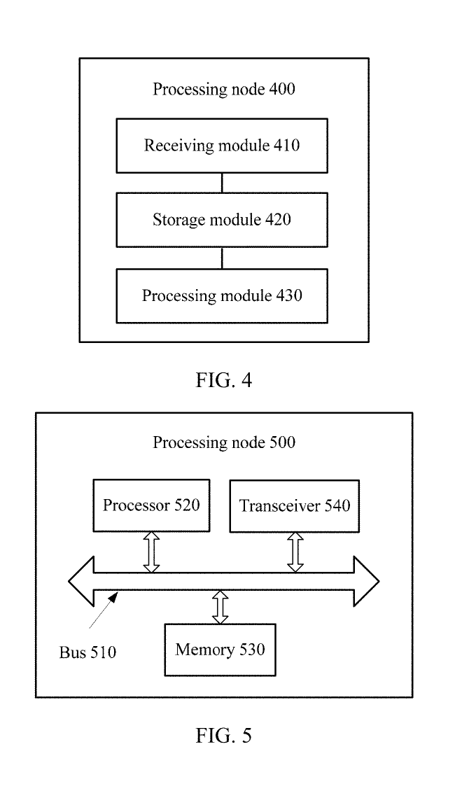

The transaction processing method according to the embodiments of the present disclosure is described above in detail with reference to FIG. 1 to FIG. 3, and a processing node and a central node according to embodiments of the present disclosure are described in the following in detail with reference to FIG. 4 to FIG. 7.

FIG. 4 shows a schematic block diagram of a processing node 400 according to an embodiment of the present disclosure. The processing node 400 belongs to a cluster and includes:
a receiving module 410, configured to receive global snapshot information sent by a central node in the cluster according to a preset time interval, where the global snapshot information includes a transaction identifier of a running transaction in the cluster;
a storage module 420, configured to store, in a cache, the global snapshot information received by the receiving module 410; and
a processing module 430, configured to process the transaction according to the global snapshot information stored in the cache.

Therefore, in the processing node provided in this embodiment of the present disclosure, global snapshot information is locally cached, and when applying for global snapshot information during transaction processing, the processing node does not need to obtain latest snapshot information from a central node in a complex message receiving and transmitting manner, but obtains locally cached global snapshot information. Therefore, network overheads can be reduced, and transaction snapshot processing efficiency can be improved.

Optionally, in an embodiment, the global snapshot information further includes a snapshot version number, where the snapshot version number is used to identify a version of the global snapshot information. The processing node 400 further includes:
a sending module, configured to send, to the central node when the processing node 400 finishes processing the transaction, an update message that indicates an end of transaction processing of the processing node, so that the central node updates the global snapshot information according to the update message.

The receiving module 410 is further configured to receive an acknowledgement message that is sent by the central node and that is used to indicate that the central node completes an update of the global snapshot information, where the acknowledgement message includes updated global snapshot information.

The storage module 420 is further configured to compare a snapshot version number included in the global snapshot information in the acknowledgement message received by the receiving module 410 with the snapshot version number included in the global snapshot information stored in the cache, and the processing node updates the global snapshot information stored in the cache to the global snapshot information in the acknowledgement message when the snapshot version number included in the global snapshot information in the acknowledgement message is higher than the snapshot version number included in the global snapshot information stored in the cache.

Optionally, in this embodiment of the present disclosure, the processing module 430 is specifically configured to:
process the transaction according to the global snapshot information sent by the central node according to the preset time interval; or
process the transaction according to the global snapshot information included in the acknowledgement message sent by the central node, where the acknowledgement message is used to indicate that the central node completes the update of the global snapshot information according to the update message sent by the processing node 400, and the update message is used to indicate the end of the transaction processing of the processing node 400.

It should be understood that the processing node 400 according to this embodiment of the present disclosure may be corresponding to an entity that executes the method in the embodiments of the present disclosure. The foregoing and other operations and/or functions of the modules in the processing node 400 are used to implement corresponding procedures of the methods in FIG. 1 to FIG. 3, and details are not described herein for brevity.

Therefore, in the processing node provided in this embodiment of the present disclosure, global snapshot information is locally cached, and when applying for global snapshot information during transaction processing, the processing node does not need to obtain latest snapshot information from a central node in a complex message receiving and transmitting manner, but obtains locally cached global snapshot information. Therefore, network overheads can be reduced, and transaction snapshot processing efficiency can be improved.

As shown in FIG. 5, an embodiment of the present disclosure further provides a central node 500. The central node 500 includes a bus 510, a processor 520, a memory 530, and a transceiver 540. The processor 520, the memory 530, and the transceiver 540 are connected by using the bus 510. The transceiver 540 invokes, by using the bus 510, a program stored in the memory 530, and is configured to receive global snapshot information sent by a central node in the cluster according to a preset time interval. The global snapshot information includes a transaction identifier of a running transaction in the cluster.

The memory 530 is configured to store, in a cache, the global snapshot information received by the transceiver 540.

The processor 520 is configured to process the transaction according to the global snapshot information stored in the cache.

Therefore, in the processing node provided in this embodiment of the present disclosure, global snapshot information is locally cached, and when applying for global snapshot information during transaction processing, the processing node does not need to obtain latest snapshot information from a central node in a complex message receiving and transmitting manner, but obtains locally cached global snapshot information. Therefore, network overheads can be reduced, and transaction snapshot processing efficiency can be improved.

It should be understood that, in this embodiment of the present disclosure, the processor 520 may be a central processing unit (CPU), or the processor 520 may be another general purpose processor, a digital signal processor (DSP), an application specific integrated circuit (ASIC), a field-programmable gate array (FPGA) or another programmable logic device, a discrete gate or a transistor logic device, a discrete hardware component, or the like. The general purpose processor may be a microprocessor, or this processor may be any normal processor, or the like.

The memory 530 may include a read-only memory and a random access memory, and provide an instruction and data to the processor 520. Apart of the memory 530 may further include a nonvolatile random access memory. For example, the memory 530 may further store information about a device type.

In addition to a data bus, the bus 510 may further include a power bus, a control bus, a status signal bus, and the like. However, for clarity of description, various buses are marked as the bus 510 in the figure.

In an implementation process, the steps of the foregoing method may be completed by using an integrated logic circuit of hardware in the processor 520 or an instruction in a form of software. The steps of the method disclosed with reference to the embodiments of the present disclosure may be directly performed by a hardware processor, or may be performed by using a combination of hardware in the processor and a software module. The software module may be located in a mature storage medium in the field, such as a random access memory, a flash memory, a read-only memory, a programmable read-only memory, an electrically-erasable programmable memory, or a register. The storage medium is located in the memory 530. The processor 520 reads information in the memory 530, and completes the steps of the foregoing method in combination with hardware of the processor 520. To avoid repetition, details are not described herein.

Optionally, in an embodiment, the global snapshot information further includes a snapshot version number, where the snapshot version number is used to identify a version of the global snapshot information. The transceiver 540 is further configured to: send, to the central node when the processing node 500 finishes processing the transaction, an update message that indicates an end of transaction processing of the processing node, so that the central node updates the global snapshot information according to the update message; and receive an acknowledgement message that is sent by the central node and that is used to indicate that the central node completes an update of the global snapshot information, where the acknowledgement message includes updated global snapshot information.

The memory 530 is further configured to compare a snapshot version number included in the global snapshot information in the acknowledgement message received by the transceiver 540 with the snapshot version number included in the global snapshot information stored in the cache, and the processing node updates the global snapshot information stored in the cache to the global snapshot information in the acknowledgement message when the snapshot version number included in the global snapshot information in the acknowledgement message is higher than the snapshot version number included in the global snapshot information stored in the cache.

Optionally, in an embodiment, the processor 520 is specifically configured to:
process the transaction according to the global snapshot information sent by the central node according to the preset time interval; or
process the transaction according to the global snapshot information included in the acknowledgement message sent by the central node, where the acknowledgement message is used to indicate that the central node completes the update of the global snapshot information according to the update message sent by the processing node, and the update message is used to indicate the end of the transaction processing of the processing node.

It should be understood that the processing node 500 according to this embodiment of the present disclosure may be corresponding to an entity that executes the method in the embodiments of the present disclosure, and may also be corresponding to the processing node 400 according to the embodiments of the present disclosure. The foregoing and other operations and/or functions of the modules in the processing node 500 are used to implement corresponding procedures of the methods in FIG. 1 to FIG. 3, and details are not described herein for brevity.

Therefore, in the processing node provided in this embodiment of the present disclosure, global snapshot information is locally cached, and when applying for global snapshot information during transaction processing, the processing node does not need to obtain latest snapshot information from a central node in a complex message receiving and transmitting manner, but obtains locally cached global snapshot information. Therefore, network overheads can be reduced, and transaction snapshot processing efficiency can be improved.

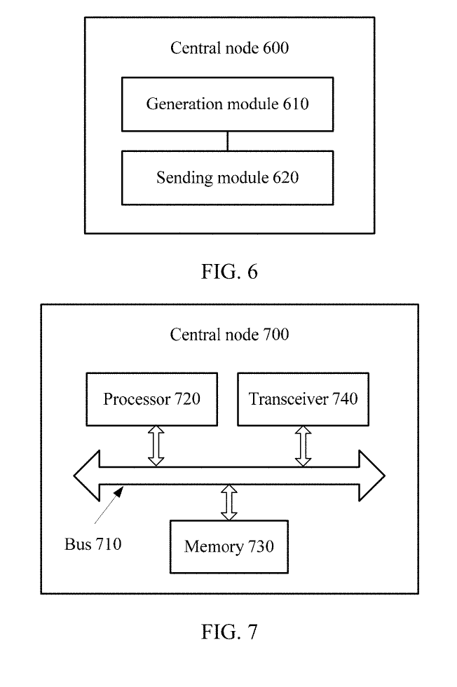

FIG. 6 shows a schematic block diagram of a central node 600 according to an embodiment of the present disclosure. The central node 600 belongs to a cluster and includes:
a generation module 610, configured to generate global snapshot information, where the global snapshot information includes a transaction identifier of a running transaction in the cluster; and
a sending module 620, configured to send the global snapshot information generated by the generation module 610 to a processing node in the cluster according to a preset time interval, so that the processing node processes the transaction according to the global snapshot information.

Therefore, in the central node provided in this embodiment of the present disclosure, latest global snapshot information is sent to each processing node according to a preset time interval, so that the processing node can store global snapshot information. When applying for global snapshot information during transaction processing, the processing node does not need to obtain latest snapshot information from the central node in a complex message receiving and transmitting manner, but obtains locally cached global snapshot information. Therefore, network overheads can be reduced, and transaction processing efficiency can be improved.

Optionally, in an embodiment, the global snapshot information further includes a snapshot version number, where the snapshot version number is used to identify a version of the global snapshot information, so that the processing node updates global snapshot information in a cache according to a number of the version.

Optionally, in an embodiment, the central node further includes:
a receiving module, configured to receive an update message sent by the processing node, where the update message is used to indicate an end of transaction processing of the processing node; and
an update module, configured to update the global snapshot information according to the update message received by the receiving module.

The sending module 620 is further configured to:
send an acknowledgement message to the processing node, where the acknowledgement message includes updated global snapshot information.

It should be understood that the central node 600 according to this embodiment of the present disclosure may be corresponding to an entity that executes the method in the embodiments of the present disclosure. The foregoing and other operations and/or functions of the modules in the central node 600 are used to implement corresponding procedures of the methods in FIG. 1 to FIG. 3, and details are not described herein for brevity.

Therefore, in the central node provided in this embodiment of the present disclosure, latest global snapshot information is sent to each processing node according to a preset time interval, so that the processing node can store global snapshot information. When applying for global snapshot information during transaction processing, the processing node does not need to obtain latest snapshot information from the central node in a complex message receiving and transmitting manner, but obtains locally cached global snapshot information. Therefore, network overheads can be reduced, and transaction processing efficiency can be improved.

As shown in FIG. 7, an embodiment of the present disclosure further provides a central node 700. The central node 700 includes a bus 710, a processor 720, a memory 730, and a transceiver 740. The processor 720, the memory 730, and the transceiver 740 are connected by using the bus 710. The processor 720 invokes, by using the bus 710, a program stored in the memory 730 to generate global snapshot information. The global snapshot information includes a transaction identifier of a running transaction in the cluster.

The transceiver 740 is configured to send the global snapshot information generated by the generation module to a processing node in the cluster according to a preset time interval, so that the processing node processes the transaction according to the global snapshot information.

Therefore, in the central node provided in this embodiment of the present disclosure, latest global snapshot information is sent to each processing node according to a preset time interval, so that the processing node can store global snapshot information. When applying for global snapshot information during transaction processing, the processing node does not need to obtain latest snapshot information from the central node in a complex message receiving and transmitting manner, but obtains locally cached global snapshot information. Therefore, network overheads can be reduced, and transaction processing efficiency can be improved.

It should be understood that, in this embodiment of the present disclosure, the processor 720 may be a central processing unit (CPU), or the processor 720 may be another general purpose processor, a digital signal processor (DSP), an application specific integrated circuit (ASIC), a field-programmable gate array (FPGA) or another programmable logic device, a discrete gate or a transistor logic device, a discrete hardware component, or the like. The general purpose processor may be a microprocessor, or this processor may be any normal processor, or the like.

The memory 730 may include a read-only memory and a random access memory, and provide an instruction and data to the processor 720. Apart of the memory 730 may further include a nonvolatile random access memory. For example, the memory 730 may further store information about a device type.

In addition to a data bus, the bus 710 may further include a power bus, a control bus, a status signal bus, and the like. However, for clarity of description, various buses are marked as the bus 710 in the figure.

In an implementation process, the steps of the foregoing method may be completed by using an integrated logic circuit of hardware in the processor 720 or an instruction in a form of software. The steps of the method disclosed with reference to the embodiments of the present disclosure may be directly performed by a hardware processor, or may be performed by using a combination of hardware in the processor and a software module. The software module may be located in a mature storage medium in the field, such as a random access memory, a flash memory, a read-only memory, a programmable read-only memory, an electrically-erasable programmable memory, or a register. The storage medium is located in the memory 730. The processor 720 reads information in the memory 730, and completes the steps of the foregoing method in combination with hardware of the processor 720. To avoid repetition, details are not described herein.

Optionally, in an embodiment, the global snapshot information further includes a snapshot version number, where the snapshot version number is used to identify a version of the global snapshot information, so that the processing node updates global snapshot information in a cache according to a number of the version.

Optionally, in an embodiment, the transceiver 740 is further configured to:
receive an update message sent by the processing node, where the update message is used to indicate an end of transaction processing of the processing node.

The processor 720 is further configured to update the global snapshot information according to the update message received by the receiving module.

The transceiver 740 is further configured to send an acknowledgement message to the processing node, where the acknowledgement message includes updated global snapshot information.

It should be understood that the central node 700 according to this embodiment of the present disclosure may be corresponding to an entity that executes the method in the embodiments of the present disclosure, or may be corresponding to the central node 600 according to the embodiments of the present disclosure. The foregoing and other operations and/or functions of the modules in the central node 700 are used to implement corresponding procedures of the methods in FIG. 1 to FIG. 3, and details are not described herein for brevity.

Therefore, in the central node provided in this embodiment of the present disclosure, latest global snapshot information is sent to each processing node according to a preset time interval, so that the processing node can store global snapshot information. When applying for global snapshot information during transaction processing, the processing node does not need to obtain latest snapshot information from the central node in a complex message receiving and transmitting manner, but obtains locally cached global snapshot information. Therefore, network overheads can be reduced, and transaction processing efficiency can be improved.

An embodiment of the present disclosure further provides a cluster, and the cluster includes multiple processing nodes according to the embodiments of the present disclosure and the central node according to the embodiments of the present disclosure.

It should be understood that, in the embodiments of the present disclosure, “Y corresponding to X” indicates that Y is associated with X and that Y may be determined according to X. However, it should be further understood that determining Y according to X does not mean that Y is determined only according to X, and Y may also be determined according to X and/or other information.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific embodiments of the present disclosure, but are not intended to limit the protection scope of the present disclosure. Any modification or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A transaction processing method, comprising:
receiving, by a processing node in a cluster, global snapshot information sent by a central node in the cluster according to a preset time interval, wherein the global snapshot information comprises a transaction identifier of a running transaction in the cluster;
storing, by the processing node, the received global snapshot information in a cache; and
processing, by the processing node, the transaction according to the global snapshot information stored in the cache.

2. The method according to claim 1, wherein:
the global snapshot information further comprises a snapshot version number; and
the method further comprises:
sending, to the central node when the processing node finishes processing the transaction, an update message that indicates an end of transaction processing of the processing node,
after sending the update message, receiving, by the processing node, an acknowledgement message sent by the central node and comprising updated global snapshot information,
comparing, by the processing node, a snapshot version number comprised in the updated global snapshot information in the acknowledgement message with the snapshot version number comprised in the global snapshot information stored in the cache, and
updating, by the processing node, the global snapshot information stored in the cache to the updated global snapshot information in the acknowledgement message when the snapshot version number comprised in the updated global snapshot information in the acknowledgement message is higher than the snapshot version number comprised in the global snapshot information stored in the cache.

3. The method according to claim 1, wherein processing, by the processing node, the transaction according to the global snapshot information stored in the cache comprises:
processing, by the processing node, the transaction according to the updated global snapshot information comprised in the acknowledgement message sent by the central node.

4. A transaction processing method, comprising:
generating, by a central node in a cluster, global snapshot information comprising a transaction identifier of a running transaction in the cluster; and
sending, by the central node, the global snapshot information to a processing node in the cluster according to a preset time interval.

5. The method according to claim 4, wherein the global snapshot information further comprises a snapshot version number.

6. The method according to claim 4, wherein the method further comprises:
receiving, by the central node, an update message sent by the processing node for indicating an end of transaction processing of the processing node;
updating, by the central node, the global snapshot information according to the update message; and
sending, by the central node, an acknowledgement message to the processing node, wherein the acknowledgement message comprises updated global snapshot information.

7. A processing node disposed within a cluster, the processing node comprising:
a receiver, configured to receive global snapshot information sent by a central node in the cluster according to a preset time interval, wherein the global snapshot information comprises a transaction identifier of a running transaction in the cluster;
a storage module, configured to store, in a cache, the global snapshot information received by the receiver; and
a processor, configured to store, in a cache, the global snapshot information received by the receiver, and process the transaction according to the global snapshot information stored in the cache.

8. The processing node according to claim 7, wherein:
the global snapshot information further comprises a snapshot version number; and
the processing node further comprises:
a transmitter, configured to send, to the central node when the processing node finishes processing the transaction, an update message that indicates an end of transaction processing of the processing node,
wherein the receiver is further configured to receive, after the update message is sent to the central node, an acknowledgement message sent by the central node and comprising updated global snapshot information, and
wherein the processor is further configured to:
compare a snapshot version number comprised in the updated global snapshot information in the acknowledgement message received by the receiver with the snapshot version number comprised in the global snapshot information stored in the cache; and
update the global snapshot information stored in the cache to the updated global snapshot information in the acknowledgement message when the snapshot version number comprised in the updated global snapshot information in the acknowledgement message is higher than the snapshot version number comprised in the global snapshot information stored in the cache.

9. The processing node according to claim 7, wherein the processor is configured to:
process the transaction according to the updated global snapshot information comprised in the acknowledgement message sent by the central node.

10. A central node disposed in a cluster, the central node comprising:
a processor, configured to generate global snapshot information comprising a transaction identifier of a running transaction in the cluster; and
a transmitter, configured to send the global snapshot information generated by the generation module to a processing node in the cluster according to a preset time interval.

11. The central node according to claim 10, wherein the global snapshot information further comprises a snapshot version number.

12. The central node according to claim 10, further comprising:
a receiver, configured to receive an update message sent by the processing node for indicating an end of transaction processing of the processing node;
wherein the processor is further configured to update the global snapshot information according to the update message received by the receiver; and
wherein the transmitter is further configured to:
send an acknowledgement message to the processing node, wherein the acknowledgement message comprises updated global snapshot information.
